(19) United States
(12) Patent Application Publication
(10) Pub. No.: US 2015/0164261 A1
(43) Pub. Date: Jun. 18, 2015

(54) BREWING PITCHER

(71) Applicant: Takeya USA Corporation, Huntington Beach, CA (US)

(72) Inventor: Shunsuke Fukumura, Habikino (JP)

(21) Appl. No.: 14/527,554

(22) Filed: Oct. 29, 2014

(30) Foreign Application Priority Data
Dec. 18, 2013 (JP) 2013-261036

(51) Int. Cl. A47J 31/06

(52) U.S. Cl. CPC A47J 31/0626; A47J 31/0636

(57) ABSTRACT

A brewing pitcher can be used for brewing and dispensing a beverage such as iced tea. The brewing pitcher can include a container body for holding a liquid, an external cap, and an infusion unit. The infusion unit can include an infusion container for holding an infusion ingredient and an inner cap. The infusion unit can be sized to fit completely within the container body with the external cap in a sealed position. The infusion unit can be further configured to engage an interior surface of the container body to suspend the infusion container within the container body in a fixed position. The brewing pitcher can be configured such that fluid can be dispensed from the container body without requiring dispensed fluid to flow through the infusion unit when the infusion unit is positioned within the container body.

### INCORPORATION BY REFERENCE TO ANY PRIORITY APPLICATIONS

This application claims priority to Japanese Patent Application No. 2013-261036 filed Dec. 18, 2013, entitled SEALED CONTAINER, the entire content of which is hereby expressly incorporated by reference herein. Any and all applications for which a foreign or domestic priority claim is identified in the Application Data Sheet as filed with the present application are hereby incorporated by reference under 37 CFR 1.57.

### BACKGROUND OF THE INVENTION

1. Field of the Invention

Certain embodiments disclosed herein relate generally to a brewing pitcher for brewing and dispensing infused beverages. In particular, they relate to brewing pitchers having removable infusers.

2. Description of the Related Art

Tea and other steeped beverages are customarily prepared by combining tea leaves, or another ingredient, and near-boiling water in a pot or other container. Typically, a screen or strainer, such as an infuser, is used to confine the tea leaves during the brewing cycle.

Various commercially available brewing pitchers have certain draw backs. Principle among them is the difficulty of removing an infusion ingredient from the pitcher. The infusion ingredient, such as tea leaves, steeps in a fluid when creating the beverage. After a given infusion time (when the desired concentration is reached), it is necessary to remove the ingredient from the fluid. This is done in many different ways depending on the design of the brewing pitcher and the infusing method.

In a brewing pitcher with a separate infuser, it may be required to fish out the infuser from the liquid. Alternatively, the infuser may need to be removed from a top cap. Some systems for removing the infuser can be time consuming and inconvenient. Furthermore, when removing an infuser from a top cap, there is the potential that the hands will be extensively wetted, and that hands can touch the bottom side of the top cap. As the bottom side is extremely likely to later be in contact with the infused beverage, this introduces sanitation issues when the top cap is put back on the container body. In addition, the infusion ingredient may adhere to the back side of the top cap, so there was a need to wash the top cap before putting it back on the container body.

### SUMMARY OF THE INVENTION

As will be understood, there exists a constant need for improvement in brewing pitchers with infusion units. A brewing pitcher can be used for brewing and dispensing infused beverages. According to certain embodiments, a brewing pitcher can provide a system where an infusion unit can be removed from a container body easily and sanitarily. After the infusion unit has been removed an external cap or lid can quickly and easily attach to the container main body.

A brewing pitcher can include a bottom container body and an external cap to seal the container body. The brewing pitcher can further include an infusion unit having an infusion container for holding a beverage infusion ingredient, and an inner cap equipped with a handle to attach to and cap the infusion container as well as freely attach and detach inside the container.

A brewing pitcher can have a first lid and a removable infuser that has a second lid so as to seal the flavoring within the infuser while sealed within the pitcher and first lid. The infuser can be removable and reusable. The first lid can be opened and closed to pour beverage from the pitcher.

A brewing pitcher can be used for brewing and dispensing a beverage such as iced tea. The brewing pitcher can include a container body for holding a liquid, an external cap, and an infusion unit. The infusion unit can include an infusion container for holding an infusion ingredient and an inner cap. The infusion unit can be sized to fit completely within the container body with the external cap in a sealed position. The infusion unit can be further configured to engage an interior surface of the container body to suspend the infusion container within the container body in a fixed position. The brewing pitcher can be configured such that fluid can be dispensed from the container body without requiring dispensed fluid to flow through the infusion unit when the infusion unit is positioned within the container body.

Furthermore, in a state where the infusion container is capped by the inner cap, one or more air bleed gaps can be provided. Small protrusions can be formed on either the top edge of the infusion container or the capping surface of the inner cap. The small protrusions can be between the top edge surface of the infusion container and the capping surface of the inner cap that forms the opposing surface to the aforementioned top edge surface to thereby create air bleed gaps.

Still further, the container body inner surface can be formed with a tapered shape that decreases downwards. The inner cap of the infusion unit can be provided with multiple vertical protrusions that can be used to contact the inner surface, thereby determining the vertical position of the infusion unit within the container body. Other systems of suspending the infusion unit within the container body can also be used.

### BRIEF DESCRIPTION OF THE DRAWINGS

Various embodiments are depicted in the accompanying drawings for illustrative purposes, and should in no way be interpreted as limiting the scope of the inventions, in which like reference characters denote corresponding features consistently throughout similar embodiments.

FIG. 1 shows a half cross-section side view of a brewing pitcher.

FIG. 2 is a cross-section side view of the brewing pitcher with the infusion unit removed and showing a container body with an attached lid.

FIG. 3 illustrates a front view of an infusion unit.

FIG. 4 is a perspective view showing a portion of the infusion unit of FIG. 3 with the container body and the inner cap detached.

FIG. 5 is a perspective view showing the bottom side of the inner cap.

FIG. 6 is a top planar view showing the infusion unit attached to the container body without the lid.

FIG. 7 shows a cross section view of the infusion unit and container body taken along line A-A of FIG. 6.

FIG. 8 illustrates the cross-section view of FIG. 7 with the lid attached to the container body.

FIG. 9 shows the brewing pitcher in use, where (a) is an explanatory diagram showing an infusion unit partially inserted into a container body, and (b) is an explanatory diagram showing an enlarged and cross-sectional view of an infusion unit partially inserted into a container body.

FIG. 10 illustrates part of a method of using the brewing pitcher, where (a) is an explanatory diagram showing the infusion unit being removed from the container body, and (b) is an explanatory diagram showing the infusion unit completely removed.

FIG. 11 is a front view of another embodiment of infusion unit.

### DETAILED DESCRIPTION

A brewing pitcher can be used for brewing and dispensing infused beverages. According to certain embodiments, a brewing pitcher can provide a system where an infusion unit can be removed from a container body easily and sanitarily. After the infusion unit has been removed an external cap or lid can quickly and easily attach to the container main body. It will be understood that many of the principles described herein can be applied to other types of containers and systems and are not limited to brewing pitchers.

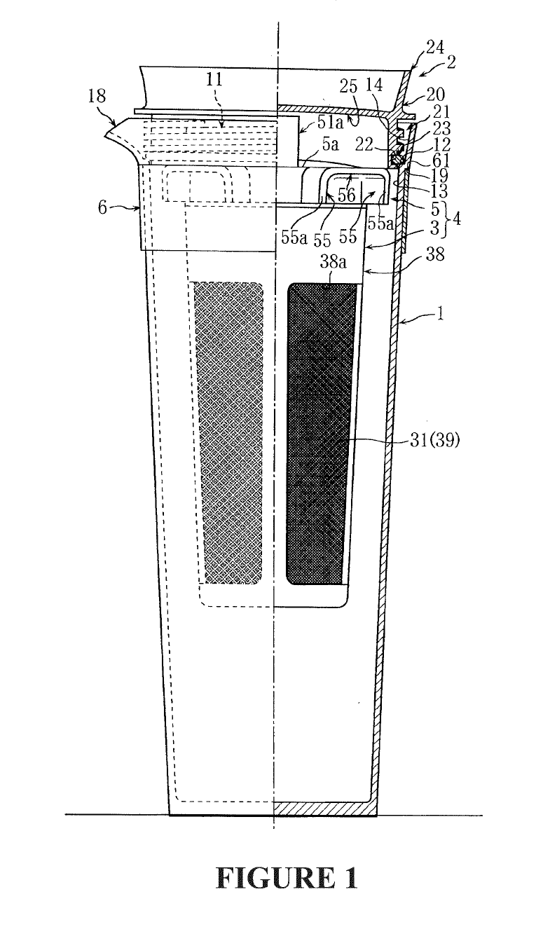

Looking now to FIG. 1, a brewing pitcher is shown. The illustrated brewing pitcher can include a bottom container body 1 and an external cap 2 to seal the container body. The brewing pitcher can further include an infusion unit 4 having an infusion container 3 for holding a beverage infusion ingredient, and an inner cap 5 equipped with a handle to attach to and cap the infusion container 3 as well as freely attach and detach inside the container 1.

The brewing pitcher according to some embodiments can include a spout 18 and a handle or a sleeve 6. A sleeve 6 can be positioned on the upper peripheral wall of the container body 1. As illustrated, a short cylindrically shaped sleeve material 6 can be pushed onto the container body 1 forming a friction fit with the container body. A top edge 61 of the sleeve 6 can be positioned adjacent a step 19 on the upper peripheral wall of container body 1 to position it vertically, as well as prevent it pulling off in the upward direction. The step 19 can be a wide diameter step surface 19. Further, the sleeve 6 can be formed as a single piece from a heat resistant plastic such as polypropylene plastic. Advantageously, when hot water is put into the container body 1, holding the sleeve 6 can insulate the user from the high temperature of the water, making the brewing pitcher easier to hold and carry.

The container body 1 of the brewing pitcher can be cylindrical, or have other shapes. It will be understood that as illustrated the brewing picture has a cylindrical container body and infusion container, the various components as illustrated are generally symmetric unless shown otherwise. Thus, many of the views not illustrated herein are mirror images of those shown, as would be understood by one of skill in the art.

In some embodiments, the container body 1 is formed with a circular shape at the top with a rounded corner square shape at the bottom and can transition therebetween along the body. The opening end can be formed as a cylinder, and as the peripheral wall moves towards the bottom end it can shrink (diameter reduces) and changes into a square shape. By shaping it in this way, it can be placed standing up in the door of a refrigerator while maximizing the internal volume. Also, when laying it down, the square cylindrical shape of the wall at the bottom prevents rolling.

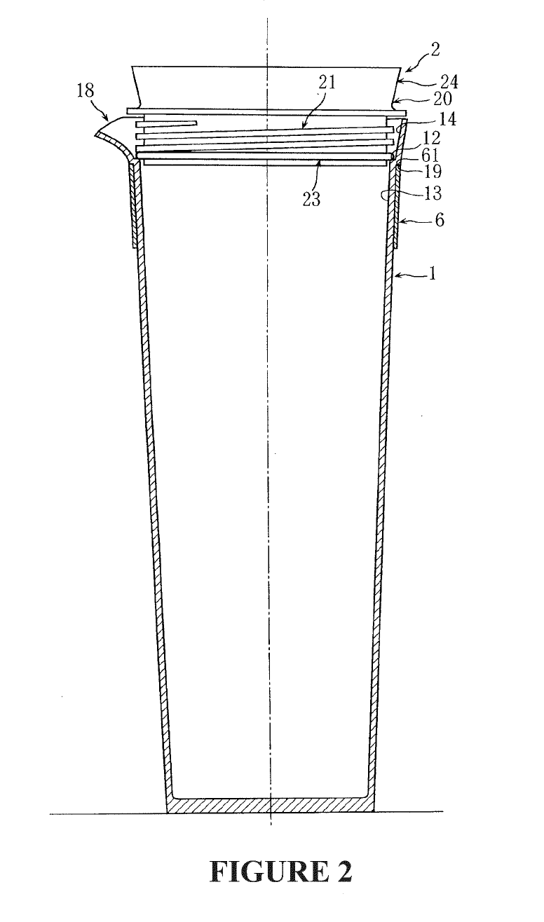

An external cap or lid 2 can seals the top opening of the container body 1 by screwing on to the container body 1, as shown in FIGS. 1 and 2. As best seen in FIG. 2, the external cap 2 has a capping material 20 provided with male threads 21 to screw into the top opening of the container body 1. In some embodiments, the lid 2 attaches to the container body 1 by friction fit or other manners.

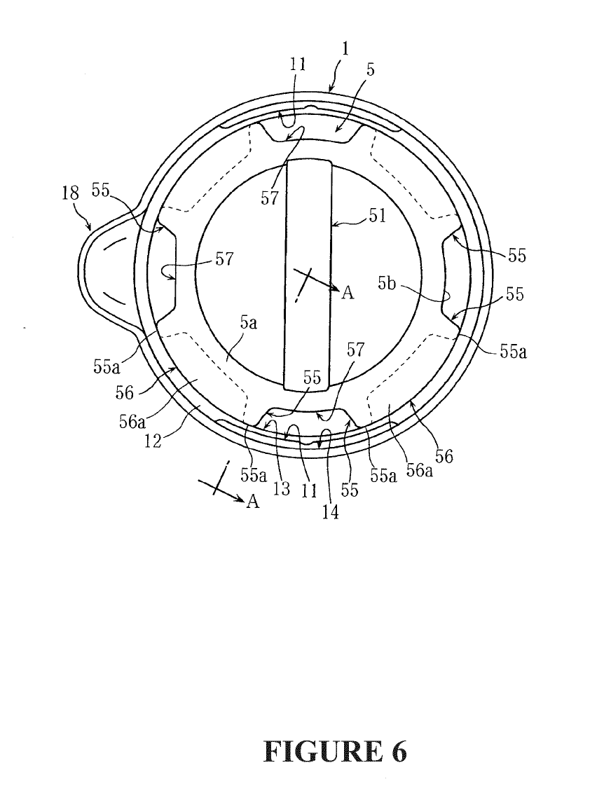

The container body 1 can include threads 11 (FIG. 1) that can engage the threads 21 on the external cap 2. The threads 11 can be a pair of projections 11, best seen in FIGS. 6 & 7. The projections 11 can be positioned on an opening inner peripheral surface 14 of the container body 1. In some embodiments, the container body 1 can include female threads formed into the surface of the container body. In still other embodiments, the external cap 2 can include female threads formed therein.

A seal material 23 can be provided on the external cap 2. The seal material 23 can seal the interface between the external cap 2 and the container body 1 when the external cap 2 is in a closed position. The seal material 23 can be a cylindrical seal material 23 (for example, silicone-manufactured O-ring). The external cap may also include a peripheral groove 22 (FIG. 1) into which the seal material 23 is attached by pressing into the peripheral groove 22. As illustrated the peripheral groove 22 and seal material 23 is shown positioned below the male threads 21. In some embodiments the peripheral groove 22 and/or seal material 23 can be positioned above the threads or other attachment feature.

The container body 1 can have a lip or step 12 with which the sealing material 23 on the external cap 2 can form an interface with the container body 1 when the external cap 2 is in a closed position. The step 12 can be positioned below the opening inner peripheral surface 14 and can extend circularly around the opening (See FIGS. 6-8). In some embodiments, the sealing material 23 can engage directly with the opening inner peripheral surface 14 or the upper inner peripheral surface 13.

Returning to FIGS. 1 and 2, it can be seen that the upper inner peripheral surface 13 positioned below the seal step surface 12 is shaped to taper inwards with the diameter gradually decreasing. As illustrated, the taper continues to the bottom of the container body 1, though in other embodiments, the taper may be limited to portions of the container body 1.

As will be described in more detail below, an infusion unit 4 can be positioned within the container body and held in place because of the taper. The infusion unit 4 can be placed within the container body 1 to hold a beverage infusion ingredient such as tea leaves or ground coffee beans.

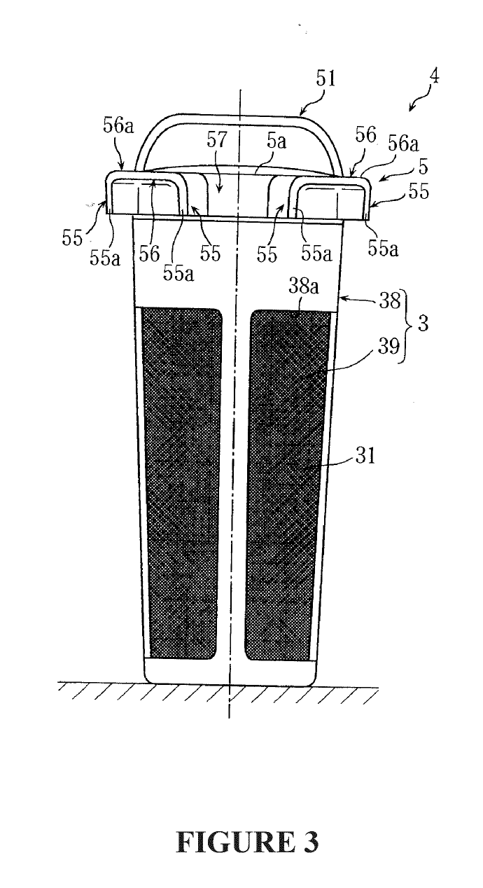

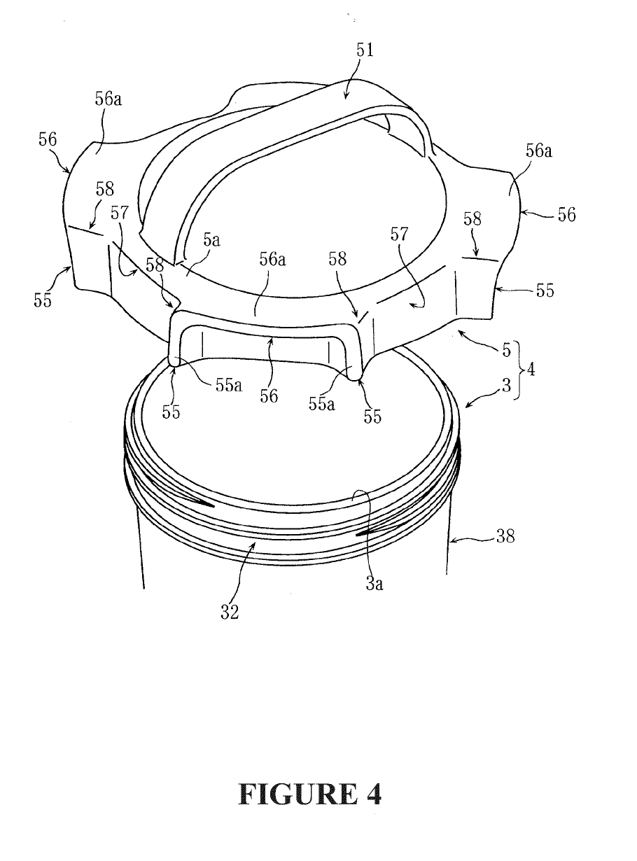

Looking now at FIGS. 3 and 4, the infusion unit 4 is shown with an infusion container 3 in order to hold the beverage infusion ingredient, and an inner cap 5. The infusion container 3 can be cylindrical or some other shape. The inner cap 5 can be equipped with a handle 51 and can screw onto the upper opening of the infusion container 3. In addition, the inner cap 5 can position the infusion unit 4 within the container body 1 by placing it within the upper inner surface 13 of the container body 1.

The infusion container 3 can include threads 32 in the upper part (FIG. 4), and an infusion filter or membrane 31 through which fluids are able to pass radially through the outer wall (FIGS. 1 & 3).

The infusion container 3 can be a single unit formed of a cylindrical piece 38 in which is formed a window 38a in the outer wall. A filter material 39, such as a mesh material, can be positioned to cover the window 38a. When die-forming the cylindrical piece 38 with heat-resistant plastic (for example, polypropylene), a previously fabricated heat-resistant plastic (for example, polyester) filter piece 39 is inserted to cover the window 38a, and then the unit is formed as a single piece.

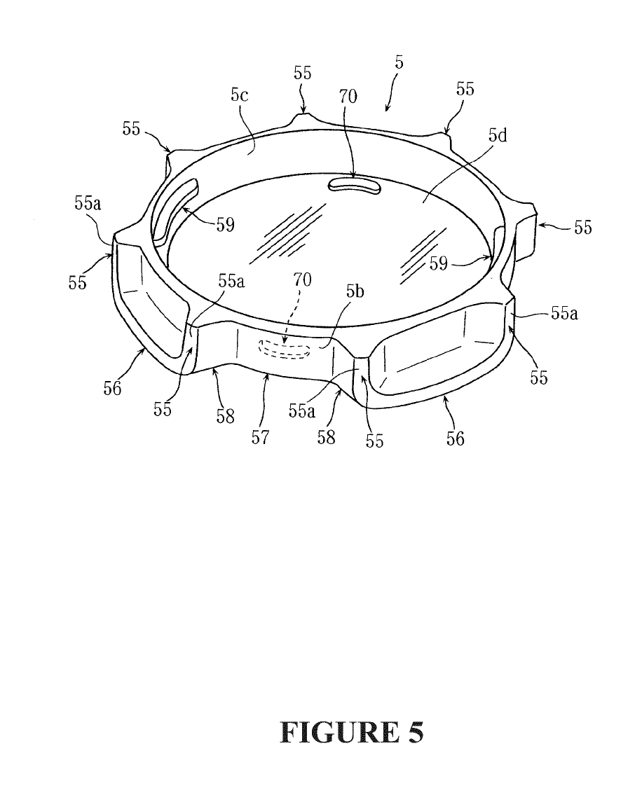

As shown in FIGS. 3-4, the inner cap 5 is a short cylindrically shaped plastic single piece, and on the top surface 5a is a projecting (arch-shaped) handle 51. The handle 51 can have any number of different shapes. On the inner peripheral surface 5c as shown in FIG. 5, a pair of screw-down projections 59, 59 may be provided. The projections 59 can project radially and be used to attach the inner cap 5 to the infusion container 3 male threads 32 (possessing the action of female threads). Other attachment methods can also be used.

The inner cap 5 can also include one or more small projections 70, on the capping surface 5d of the inner cap 5. A pair of projections 70 are shown, which when completely screwed onto the infusion container 3 can become the opposing surface to the upper edge 3a (FIG. 4) of the infusion container 3.

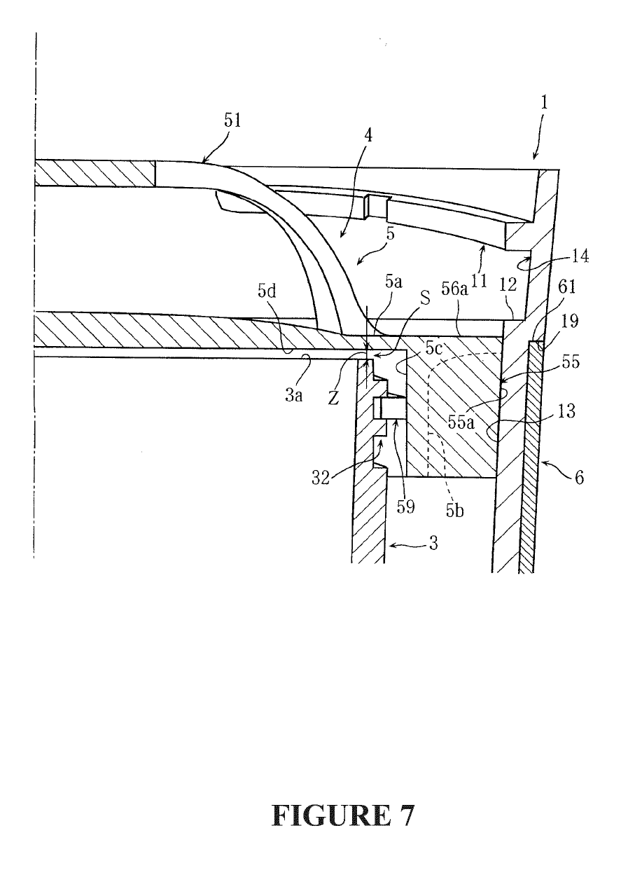

In the capped state of the infusion unit 4, the small projections 70 are formed so that the capping surface 5d of the inner cap 5 does not form a seal with the upper edge 3a of the infusion container. As can be seen in FIG. 7-9, a gap “S” is formed to allow for air passage between the infusion container 3 and the inner cap 5. The gap “S” has a gap dimension “Z” which can correspond to a dimension of the small protrusion 70.

When the infusion unit 4 with a beverage infusion ingredient is placed into a water filled container body 1, water can pass through the infusion filter 31 and flows into the infusion container 3. Due to that inflow, the air inside the infusion unit 4 can exhaust through the gap S formed by the small protrusions 70.

The gap dimension “Z” and the dimension of the small protrusions 70 can be set to prevent the beverage infusion ingredient from leaving the infusion unit 4 in any significant amount. In some embodiments the gap dimension is 0.1 mm or more or less than 1 mm. In some embodiments the gap dimension is 0.05 to 5 mm, 0.075 to 3 mm, or 0.075 to 2 mm.

Next, the attachment of the container body 1 and the inner cap 5 of the infusion unit 4 will be explained. As shown in FIGS. 1-2, the illustrated top inner peripheral surface 13 of the container body 1 is formed in a taper shape that decreases in diameter (shrinks) moving downwards. In other words, the container body 1 upper part is provided with a taper-shaped inner surface 13 of a downward decreasing diameter. Looking at FIG. 5, it can be seen that multiple protrusions 55, 56 extend outward on the inner cap 5. These protrusions 55, 56 on the inner cap 5 can be used to engage the upper inner peripheral surface 13 of the container body 1, as shown in FIGS. 6-7. The protrusions 56, 55 can protrude radially from the outer peripheral surface 5b (cylinder wall) of the inner cap 5. In some embodiments the protrusions 55, 56 can extend vertically, though they can also be angled from vertical.

The inner cap 5 can include any number of protrusions 55, 56. The protrusions can be small or large and can take a number of different shapes. In addition, different style protrusions can be used on the same inner cap 5. As can be seen with reference to FIG. 5, the protrusions 55 are relatively small and the protrusions 56 are relatively large and include two of the smaller protrusions 55. When viewed from the top, the protrusions 55 are not as apparent, as the larger protrusions 56, or they may not be seen at all. When viewed from the bottom both types of protrusions are readily apparent. As the infusion unit 4 slides into the container body 1, the bottom of the protrusions interact with the inner periphery surface 13 (container body wall). Thus, the cylinder wall may contact the smaller protrusions 55 before engaging the larger protrusions 56. It will also be understood that when at rest, certain of the protrusions 55 and certain of the protrusions 56 may engage the inner periphery surface 13, none of one group may be engaged, or only some of one or both groups may be engaged.

The protrusions 55, 56 can be tapered to correspond with the taper of the inner periphery surface 13. In some embodiments, the protrusions 55, 56 can have less taper than the taper of the inner periphery surface 13. In some embodiments, the protrusions 55, 56 can have a flat face without any taper.

From the bottom view of FIG. 5, it can be seen that eight equally spaced protrusions 55 are provided radiating from the outer periphery surface 5b. A projection edge surface 55a of each protrusion 55 can be inclined and can have an angle the same as the taper shape of the inner periphery surface 13. The projection edge surface 55a can be a radially outwards edge surface. It is preferable to provide 6 to 12 vertical projections 55. If there are 5 or fewer, the positional stability can degrade, and if there are 13 or more, attachment and detachment can become difficult, and the upper inner peripheral surface 13 of the container body 1 must be formed with high precision.

As shown in FIG. 7, the protrusion tip edge 55a of the vertical protrusion 55 of inner cap 5 can fit tightly against the taper shaped inner peripheral surface 13 of the container 1. This can prevent the inner cap 5 from moving downwards (towards the bottom of container body 1), so that the inner cap 5 is attached at a given vertical position. The pressing force of the protrusions 55, 56 on the container body 1 is sufficient that if the infusion unit 4 is empty and the container body is turned upside down, the infusion unit 4 will not fall out of the container body 1 due to its own weight. But, at the same time, the infusion unit 4 can be easily pulled out of the container body 1 with the handle 51 of the inner cap 5.

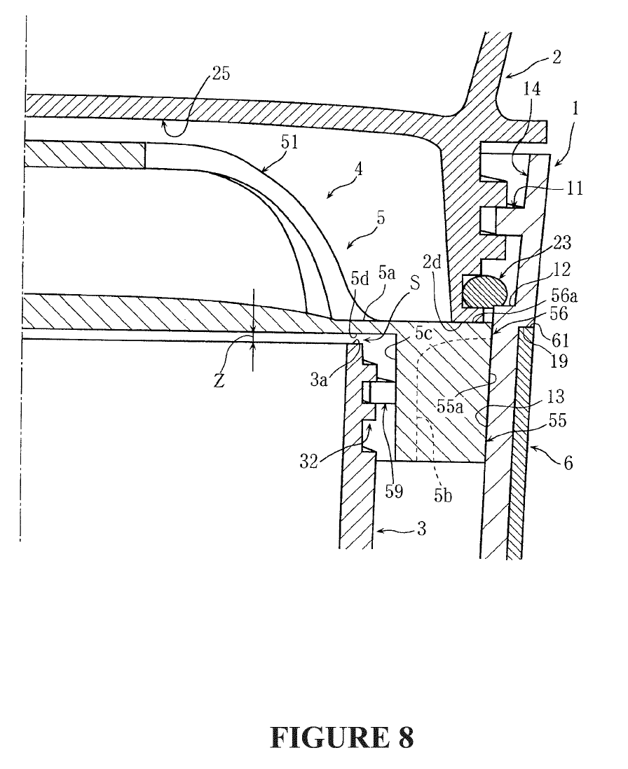

As shown in FIG. 8, after the infusion unit 4 is inserted and pressed into the container body 1, the external cap 2 can be screwed down onto the container body 1. The seal material 23 can then form a seal with the sealing step surface 12, sealing the space between the container body 1 and the external cap 2. The bottom surface of the external cap 2 can also press against the top 5a of the inner cap 5. That is to say, the inner cap 5, on the upper side 5a, can be provided with a bearing surface 56a that can contact the bottom edge surface 2d of the external cap 2 in an infusion sealed state. The bearing surface 56a can be formed on the top surface of the multiple horizontal protrusions 56 on the outer peripheral surface 5b of the inner cap 5, as shown in FIG. 6. The bearing surface 56a can be radially outwards following the periphery.

As illustrated, the horizontal protrusions 56 are provided continuously in 4 locations such that they continue in the peripheral direction between the top edge of a first vertical protrusion 55 and the top edge of a second vertical protrusion 55. Preferably 2 to 6 horizontal protrusions 56 are provided.

As shown in FIG. 8, with the external cap 2 pressed against the inner cap 5, the infusion unit 4 can remain in place, even if the container body 1 is shaken or falls over. In short, the external cap 2 can both prevent the infusion unit 4 (inner cap 5) from pulling out, and can preserve the infusion unit 4 position within the container body 1. It will be understood that the external cap 2 is not required to contact the infusion unit 4 in use and other embodiments may not have any contact between the external cap 2 and the infusion unit 4.

On the bottom side of the external cap 2 a concave area 25 can be provided as illustrated. This space can form a downward opening storage space (handle escape space) into which the handle 51 of the inner cap 5 can be positioned. Even with a handle 51, the external cap 2 and inner cap 5 can be placed close together vertically, enabling the interior of the container body 1 to be efficiently used.

Furthermore, as shown in FIG. 6, the inner cap 5 has flow paths 57 for the infused beverage to flow through, between a first vertical protrusion 55 and second vertical protrusion 55 where a horizontal protrusion 56 is not provided. There are multiple flow paths 57 located circumferentially, enabling the pouring opening or spout 18 of the container body 1 to be easily used.

Furthermore, as shown in FIG. 4, the center part of the upper surface 5a of the inner cap 5 is formed in a curved shape (swollen into a dome shape). Together with the dome shape, other features are formed so that droplets due to condensation to not gather on the upper surface 5a of the inner cap 5. For example, edge sections, corner sections, and connecting sections of vertical protrusions 55 and horizontal protrusions 56 are round chamfered to facilitate drainage of fluid off of the upper surface 5a.

Furthermore, as shown in FIGS. 4 and 5, it is preferable that the connecting edge section 58 of the vertical protrusion 55 and horizontal protrusion 56 that touch (are adjacent to) the fluid path 57 have a chamfer of 3 mm or more of radius so that water droplets on the upper surface 5a will flow easily to the bottom end of the container body 1.

Furthermore, it is preferable to provide the connecting corner sections between the vertical protrusion 55 and horizontal protrusion 56, and the connecting corner sections between the vertical protrusion 55 and the outer peripheral surface 5b, and the connecting corner sections between the horizontal protrusion 56 and the outer peripheral surface 5b, and the connecting corner sections between the vertical protrusion 55 and the outer peripheral surface 5b and the outer peripheral surface 5b, a round chamfering having a minimum 3 mm radius to make cleaning easier. It will be understood that other sizes and shapes can also be used.

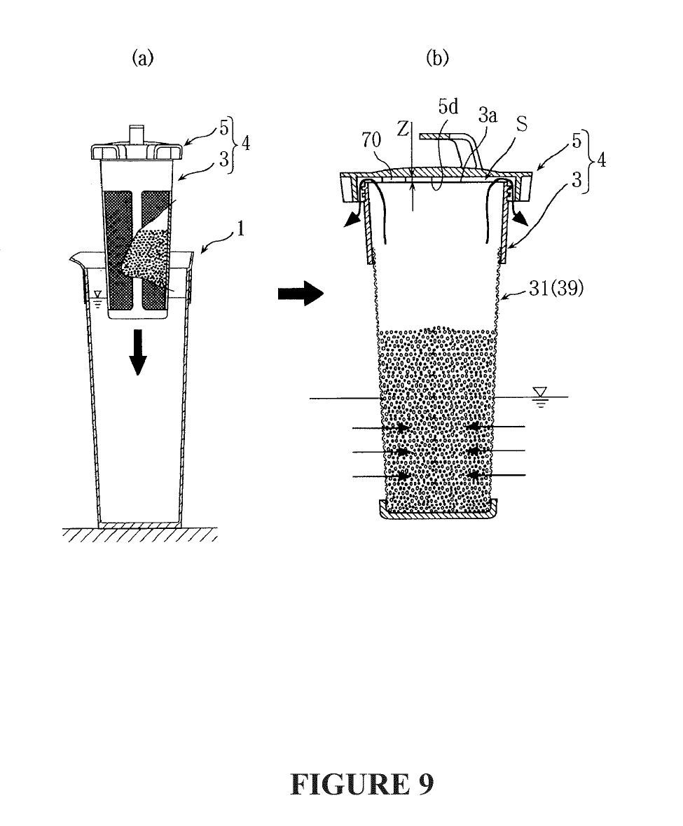

Next, a method for using the brewing pitcher will be explained. Looking first at FIG. 9 under the heading (a), a given amount of water has been put in the container body 1. An infusion unit 4 holding an ingredient, such as tea leaves, is being inserted into the container 1 so as to submerge in the water.

Then, as shown in FIG. 9 under heading (b), a detail view of the infusion unit within the container body 1 is shown. It can be seen that water can pass through the infusion filter 31 and flow into the infusion container 3. Due to that inflow, the air inside the infusion unit 4 can exhaust through the gap S formed by the small protrusions 70 as illustrated by the curved arrows.

If small protrusions 70 are not provided the capping surface 5d of the inner cap 5 and the top edge 3a of the infusion container 3 can create a seal. This can prevent air from flowing out of the infusion container 3. In this case, it can be difficult for the water to flow into the infusion container 3 because the air can become trapped in the infusion unit. Due to the submergence of the infusion unit 4, the water can be pushed aside, and it may overflow from the container body 1.

The small protrusions 70 can provide an air escape path (exhaust path). This can help ensure that water will flow into the infusion container 3, and helping to prevent overflow from the container body 1. In particular, the infusion filter 31 for coffee has a very fine mesh, and because there is a risk that water inflow will not be smooth, this is ideal for a coffee infusion unit 4.

Incidentally, because the given gap dimension Z (the protrusion dimension of the small protrusion 70) of gap S is set to be from 0.1 mm or more to less than 1 mm, even if the container unit 1 is positioned sideways, the beverage infusion ingredient, having sucked in the water and swollen, will not leak from the gap S in any large quantity.

Furthermore, as shown in FIG. 5, the protrusions 59 positioned on the inner peripheral surface 5c of the inner cap 5 can be sized to further assist with air flow leaving the infusion unit. The protrusions can be used to screw down the inner cap. As shown, there are two screw-down protrusions 59 of length 5% minimum to 25% maximum of the inner circumferential length. Compared to a full male thread (spiral-shaped protrusion) that circles the entire inner peripheral surface 5c or more, the protrusions 59 can allow for air to escape even in a screwed-down state.

Returning now to a method of use, as shown in FIG. 7, the infusion unit 4 can be attached to the container body 1 by pressing it in. Then, as shown in FIG. 8, the outer cap can be screwed down to seal the container unit 1. This may also prevent the infusion unit 4 from coming out. After a given infusion time period (until the desired concentration is reached), it can be stored in a refrigerator to create a cold brewed beverage.

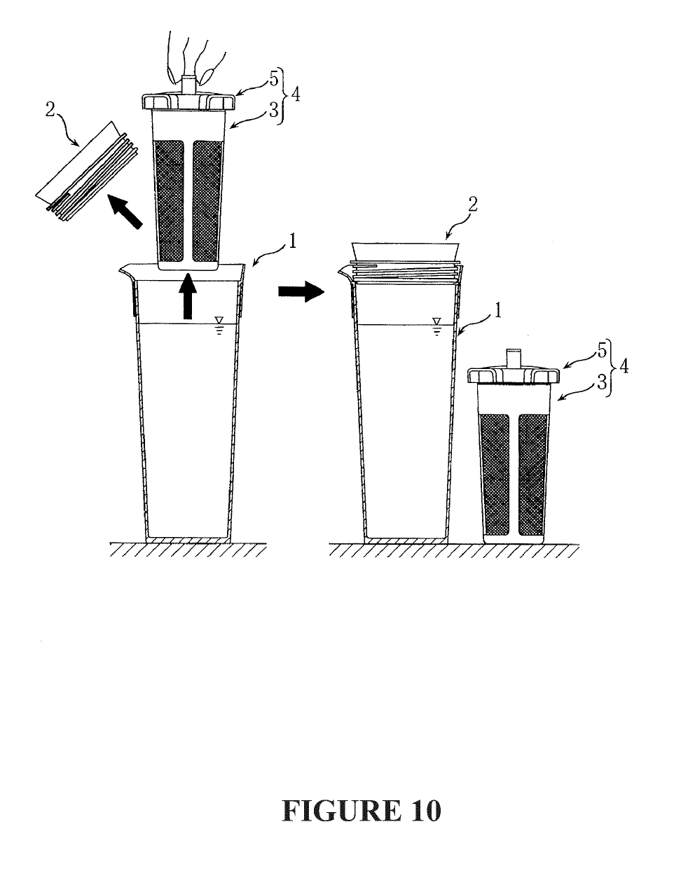

Next, after the given infusion time period (until the desired concentration is reached), as shown in FIG. 10 (a), the external cap 2 can be removed. Then the handle 51 of the inner cap 5 can be grasped and pulled up, removing the infusion unit 4 (the infusion container 3 attached by the inner cap 5) from the container body 1. After that, as shown in FIG. 10 (b), by just placing the infusion unit 4 on a surface, the external cap 2 can immediately be screwed down onto the container body 1. The cold brewed beverage is now ready to consume. By grasping the handle 51, one's hand is not excessively wetted by the infused beverage and the task can be completed sanitarily (cleanly).

In contrast, if the inner cap 5 is obviated and the infusion container is attached directly to the external cap the chance for contamination of the beverage is much greater. After a given infusion time, the external cap would be removed from the container body, and the infusion container would be removed from the external cap. It would then be necessary to attach the external cap back onto the container body. This raises the issue of increasing the time to prepare, but also, there is a problem that the hands will be wetted, and the hand will likely touch the bottom side of the external cap. As this surface will likely be contacted by the beverage it is no longer sanitary. In addition, some of the ingredient from the beverage infusion may have adhered to the underside of the external cap. It may then mix into the infused beverage. Thus, it may be necessary to wash the external cap before reattaching to the container body. In short, the disclosed brewing pitcher can solve these kinds of problems.

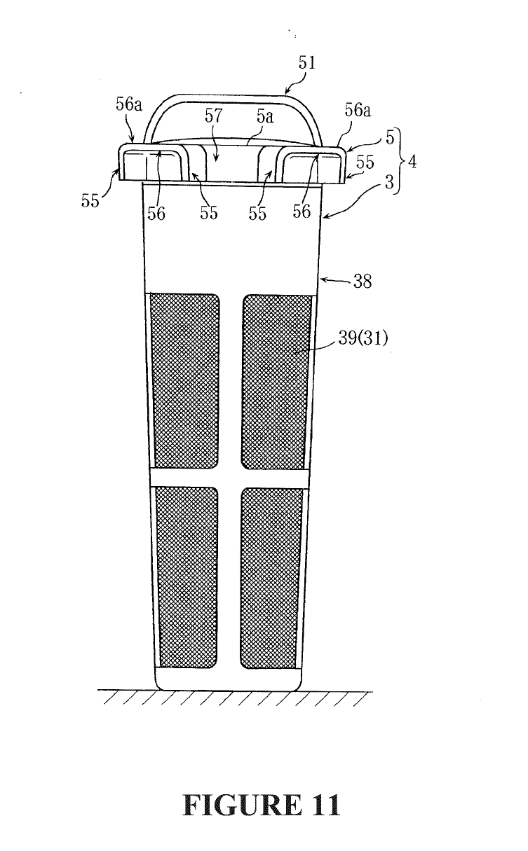

Turning now to FIG. 11, another embodiment of infusion unit 4 is shown. This infusion unit 4, when compared to the infusion unit 4 in FIG. 3, has a greater length of the infusion container 3, and a larger volume. Furthermore, the area provided for the infusion filter 31 (filter material 39 as installed) is large, and the mesh size of the infusion filter 31 (mesh of the filter material 39) is not fine (large). This infuser unit can be optimal for herbs or tea leaves, infusion beverage ingredients that are large compared to coffee grounds (ground coffee beans). It will be understood that the infuser unit of FIG. 11 is functionally the same or similar to that previously described.

It will be understood that the brewing pitcher can include many different embodiments. For example, the protrusion 70 can also protrude to the top edge 3a of the infusion container 3 (cylindrical piece 38). The shape of the handle 51 on the inner cap 5 can be different from that as shown in the figures, such as a grip shape. The holding part 24 of the external cap 2 can also be other than the shown peripheral wall shape, a side view arch shape or a grip shape will do. Furthermore, the press bearing surface 56a can also be, if it is the top surface 5a side, a part of the top surface 5a, or the top edge surface of the handle 51 or vertical protrusion 55. Also, the beverage infusion ingredients can be pulverized coffee beans, or green tea or barley tea and other Japanese teas, Chinese teas, black teas, herb and other ingredients (including leaves).

As described above, some embodiments of brewing pitcher are provided with a cylindrical container body 1, an external cap 2 to seal the container body 1, a cylindrical infusion container 3 for holding beverage infusion ingredient, an inner cap 5 with a handle that caps the infusion container 3 as well as freely attaching inside the container body 1, and that can easily and quickly remove the infusion container 3 from the container body 1, and after the infusion container 3 is removed from the container body 1, the external cap 2 can be immediately attached to the container body 1, and can be smoothly returned to the storage position in the refrigerator. When removing the infusion container 3, the hands do not become wetted, and moving the container body 1 or opening and closing the refrigerator can be performed sanitarily. There is no risk of the hands contacting the bottom surface of the external cap 2, and the time and effort to sanitarily clean the external cap 2 can be reduced.

Furthermore, with the inner cap 5 attached and capping the infusion container 3, between the top edge 3a of the infusion container 3 and the inner cap 5 capping surface 5d which opposes the top edge 3a, a small protrusion 70 is formed either on the top edge 3a or the capping surface 5d to form a gap S for air escape. So, when the infusion unit 4 (infusion container 3 attached to the inner cap 5) is inserted into the container body 1 which is holding water, the water can flow smoothly into the infusion unit 4, and water can be prevented from overflowing from the container body 1. This can facilitate the task being performed cleanly and sanitarily.

Furthermore, the container body 1 inner peripheral surface 13 can be formed in a taper shape of decreasing diameter moving downwards. The inner cap 5 can include multiple vertical protrusions 55 for determining the vertical position, which can contact with a vertical linear shape of the upper inner surface 13. Because the inner cap 5 can be attached by being pushed into place in the container 1, the infusion unit 4 (infusion container 3 attached to the inner cap 5) can be easily and quickly attached and detached in the container unit 1. The structure is simple and the number of parts can be reduced, and additionally they can be easily formed from plastic. Also, even if the upper inner surface 13 of the container 1 is not a true circle, it can firmly and stably hold its form without looseness, and the given vertical position can be accurately positioned.

A brewing pitcher can be used for brewing and dispensing a beverage such as iced tea. The brewing pitcher can include a container body for holding a liquid, an external cap, and an infusion unit. The infusion unit can include an infusion container for holding an infusion ingredient and an inner cap. The infusion unit can be sized to fit completely within the container body with the external cap in a sealed position. The infusion unit can be further configured to engage an interior surface of the container body to suspend the infusion container within the container body in a fixed position. The brewing pitcher can be configured such that fluid can be dispensed from the container body without requiring dispensed fluid to flow through the infusion unit when the infusion unit is positioned within the container body.

Furthermore, in a state where the infusion container is capped by the inner cap, one or more air bleed gaps can be provided. Small protrusions can be formed on either the top edge of the infusion container or the capping surface of the inner cap. The small protrusions can be between the top edge surface of the infusion container and the capping surface of the inner cap that forms the opposing surface to the aforementioned top edge surface to thereby create air bleed gaps.

Still further, the container body inner surface can be formed with a tapered shape that decreases downwards. The inner cap of the infusion unit can be provided with multiple vertical protrusions that can be used to contact the inner surface, thereby determining the vertical position of the infusion unit within the container body. Other systems of suspending the infusion unit within the container body can also be used.

In some embodiments, a brewing pitcher can be for brewing and dispensing a beverage. The brewing pitcher can comprise a container body for holding a liquid and comprising an interior surface having a side wall; an external cap removably attached to the container body; and an infusion unit positioned completely within the container body with the external cap removably attached to the container body. The infusion unit can comprise an infusion container for holding a beverage infusion ingredient, the infusion container having a plurality of openings to allow fluid to flow into and out of the infusion container; and an inner cap attached to the infusion container, the inner cap engaged with the side wall of the container body's interior surface and suspending the infusion container within the container body, the inner cap comprising at least one of a protrusion and an opening to allow fluid to be dispensed from the container body by flowing around the protrusion or through the opening and without requiring the fluid to flow through the infusion unit to be dispensed.

According to some embodiments, the at least one of a protrusion and an opening comprises four equally spaced protrusions extending from the periphery of the inner cap. Each of the four protrusions can comprise an arch positioned and shaped to facilitate drainage of fluid off of the inner cap. The infusion unit can be removably attached to the container body by a friction fit. The inner cap can comprise a handle and the external cap can comprise a cavity configured to receive the handle of the inner cap.

In some embodiments, the infusion unit can further comprise at least one interior protrusion on either an underside of the inner cap or a top edge of the infusion container, the at least one interior protrusion can be configured to provide an air gap between the inner cap and the infusion container when the inner cap is attached to the infusion container. The at least one interior protrusion can comprise two interior protrusions on the underside of the inner cap positioned to engage the top edge of the infusion container when the inner cap is attached to the infusion container. In some embodiments there are no holes in the inner cap.

The infusion container can have a side wall defining the plurality of openings and a top portion without any openings, the top portion providing a space to grip the infusion container to assist in removing the inner cap from the infusion container. The top portion can comprise at least the top ⅛, ¼, ⅓, etc. of the side wall.

According to some embodiments, a brewing pitcher can include a container body for holding a liquid, an external cap to close and/or seal the container body, and an infusion unit. The infusion unit can include an infusion container having a plurality of openings to allow fluid to flow into and out of the infusion container and an inner cap configured to attach to the infusion container. The infusion unit can be sized to fit completely within the container body with the external cap in a closed and/or sealed position. The infusion unit can be configured to engage an interior surface of the container body to suspend the infusion container within the container body in a fixed position. The brewing pitcher can be configured such that fluid can be dispensed from the container body without requiring dispensed fluid to flow through the infusion unit when the infusion unit is positioned within the container body.

The inner cap can be sized to engage the interior surface of the container body with a friction fit to suspend the infusion container within the container body in a fixed position. The interior surface of the container body can be tapered, with a downwardly decreasing diameter, and the inner cap further comprising multiple vertical protrusions to contact the interior surface of the container body to form a friction fit with the interior surface. The inner cap can have a handle and the external cap can define a bottom chamber configured to receive the handle when the infusion unit is positioned in the container body with the external cap in the sealed position. The infusion unit can further comprise a small protrusion, where in a capped state of the inner cap to the infusion container, in between a top edge of the infusion container and an opposing capping surface of the inner cap, the small protrusion forms a gap for leaking air, the small protrusion on either the upper edge or the capping surface.

In order to simplify the explanation of the brewing pitcher, it has been described with reference to a standard position placed on a horizontal planar surface with its axial center (lengthwise direction) placed perpendicularly. Based on this orientation and description, it will be understood that terms such as bottom, top, under, above, etc. are not limitations but are merely used to facilitate the discussion.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of skill in the art based upon this disclosure. It is also contemplated that various combinations or sub-combinations of the specific features and aspects of the embodiments may be made and still fall within the scope of the invention. Accordingly, it should be understood that various features and aspects of the disclosed embodiments can be combined with or substituted for one another in order to form varying modes of the disclosed invention. Thus, it is intended that the scope of the present invention herein disclosed should not be limited by the particular disclosed embodiments described above, but should be determined only by a fair reading of the claims that follow.

Similarly, this method of disclosure, is not to be interpreted as reflecting an intention that any claim require more features than are expressly recited in that claim. Rather, as the following claims reflect, inventive aspects lie in a combination of fewer than all features of any single foregoing disclosed embodiment. Thus, the claims following the Detailed Description are hereby expressly incorporated into this Detailed Description, with each claim standing on its own as a separate embodiment.

What is claimed is:

1. A brewing pitcher for brewing and dispensing a beverage comprising:
a container body for holding a liquid and comprising an interior surface having a side wall;
an external cap removably attached to the container body;
an infusion unit positioned completely within the container body with the external cap removably attached to the container body, the infusion unit comprising:
an infusion container for holding a beverage infusion ingredient, the infusion container having a plurality of openings to allow fluid to flow into and out of the infusion container; and
an inner cap attached to the infusion container, the inner cap engaged with the side wall of the container body's interior surface and suspending the infusion container within the container body, the inner cap comprising at least one of a protrusion and an opening to allow fluid to be dispensed from the container body by flowing around the protrusion or through the opening and without requiring the fluid to flow through the infusion unit to be dispensed.

2. The brewing pitcher of claim 1, wherein the at least one of a protrusion and an opening comprises four equally spaced protrusions extending from the periphery of the inner cap.

3. The brewing pitcher of claim 2, wherein each of the four protrusions comprises an arch, the arch positioned and shaped to facilitate drainage of fluid off of the inner cap.

4. The brewing pitcher of claim 1, wherein the infusion unit is removably attached to the container body by a friction fit.

5. The brewing pitcher of claim 1, wherein the inner cap further comprises a handle and the external cap comprises a cavity configured to receive the handle of the inner cap.

6. The brewing pitcher of claim 1, wherein the side wall of the container body's interior surface is tapered downward such that a bottom of the container body is smaller than a top.

7. The brewing pitcher of claim 1, wherein the infusion unit further comprises at least one interior protrusion on either an underside of the inner cap or a top edge of the infusion container, the at least one interior protrusion configured to provide an air gap between the inner cap and the infusion container when the inner cap is attached to the infusion container.

8. The brewing pitcher of claim 7, wherein the at least one interior protrusion comprises two interior protrusions on the underside of the inner cap positioned to engage the top edge of the infusion container when the inner cap is attached to the infusion container.

9. The brewing pitcher of claim 7, wherein there are no holes in the inner cap.

10. The brewing pitcher of claim 1, wherein the infusion container has a side wall defining the plurality of openings and a top portion without any openings, the top portion providing a space to grip the infusion container to assist in removing the inner cap from the infusion container.

11. The brewing pitcher of claim 10, wherein the top portion comprises at least the top ¼ of the side wall.

12. A brewing pitcher for brewing and dispensing a beverage comprising:
a container body for holding a liquid;
an external cap to seal the container body;
an infusion unit comprising:
an infusion container for holding a beverage infusion ingredient, the infusion container having a plurality of openings to allow fluid to flow into and out of the infusion container; and
an inner cap configured to attach to the infusion container;
wherein the infusion unit is sized to fit completely within the container body with the external cap in a sealed position, the infusion unit further configured to engage an interior surface of the container body to suspend the infusion container within the container body in a fixed position, the brewing pitcher configured such that fluid can be dispensed from the container body without requiring dispensed fluid to flow through the infusion unit when the infusion unit is positioned within the container body.

13. The brewing pitcher of claim 12, wherein the inner cap is sized to engage the interior surface of the container body with a friction fit to suspend the infusion container within the container body in a fixed position.

14. The brewing pitcher of claim 13, wherein interior surface of the container body is tapered, with a downwardly decreasing diameter, and the inner cap further comprising multiple vertical protrusions to contact the interior surface of the container body to form a friction fit with the interior surface.

15. The brewing pitcher of claim 12, wherein the inner cap further comprises a handle and the external cap defining a bottom chamber configured to receive the handle when the infusion unit is positioned in the container body with the external cap in the sealed position.

16. The brewing pitcher of claim 12, wherein the infusion unit further comprising a small protrusion, where in a capped state of the inner cap to the infusion container, in between a top edge of the infusion container and an opposing capping surface of the inner cap, the small protrusion forms a gap for leaking air, the small protrusion on either the upper edge or the capping surface.
